(19) United States
(12) Patent Application Publication
(10) Pub. No.: US 2015/0188779 A1
(43) Pub. Date: Jul. 2, 2015

(54) SPLIT-APPLICATION INFRASTRUCTURE

(71) Applicant: Jut, Inc., San Francisco, CA (US)

(72) Inventors: Steven McCanne, San Francisco, CA (US); Michael Demmer, San Francisco, CA (US)

(21) Appl. No.: 14/569,426

(22) Filed: Dec. 12, 2014

Related U.S. Application Data
(60) Provisional application No. 61/922,426, filed on Dec. 31, 2013.

(51) Int. Cl. H04L 12/24; H04L 29/06

(52) U.S. Cl. CPC H04L 41/50; H04L 67/42

(57) ABSTRACT

Methods and systems for managing software as a service include receiving a request from a client, and as a result of receiving the request, providing a response to the client request including a mechanism for permitting cross-origin requests. An application can provide to the client a mechanism for permitting cross-origin requests and a client can receive user data from a user-controlled data repository. Methods and systems can manage a user application using user data within the user-controlled data repository, according to the cross-origin requests permissions.

### CROSS-REFERENCES TO PRIORITY AND RELATED APPLICATIONS

This application claims priority to and is a non-provisional of U.S. Provisional Patent Application No. 61/922,426, filed Dec. 31, 2013, and entitled “JUT AGENT INFRASTRUCTURE” the entire disclosures of which are incorporated by reference herein in their entireties for all purposes.

### FIELD OF THE INVENTION

Various aspects of the present disclosure relate to, but are not limited to, the field of distributed computer applications, and more particularly to distributed computer applications that use a common interface to provide access from computer applications remotely stored to user data that is secured behind a user trust boundary.

### BACKGROUND OF THE INVENTION

Software-as-a-Service (“SaaS”) broadly describes networked environments wherein a client executes software that is provided by a SaaS server, typically on an as-needed basis. One of the touted benefits of SaaS use is that the client users do not have to maintain and update the software, as it is maintained “as a service” and provided to the client device as needed. Examples of SaaS include Salesforce.com®. SaaS software might be provided as JavaScript® program code that is downloaded to a client device and executed there.

For security reasons, it is preferable that the SaaS software executing on the client be normally blocked from accessing data from an unrelated site (“cross-site requesting”), while at the same time being allowed to access data from a site related to the site that provided the SaaS software. As a result, a common configuration is to have a common domain that maintains, serves, etc. both the SaaS software and the data that is read/written/etc. by the SaaS software.

For example, consider a banking or customer relationship management (“CRM”) application that is provided using a SaaS model as an application downloaded to, and executed by, the client device. Often, the user data is stored in the same domain as the applications that use that user data so that requests from different hosts comprising this common service would not be interpreted as cross-site requests and be blocked.

Different procedures exist for protecting a client (e.g., an Internet browser), access to data, and a transport channel between the client and an application. For example, a mechanism called Cross-Origin Resource Sharing (“CORS”) enables safe sharing of resources when the resources come from different origins that mutually trust one another. For example, when a first service wants to serve the application from a first domain and have the data stored in a second domain, then in response to cross-domain requests originating from the first domain, the second domain would use a CORS header to authorize access to the data from the trusted origin. Further, an open standard to authorization (“OAuth”) provides resource owners with a method of authorizing third-party access to the server resources without sharing their credentials. Last, cryptographic protocols such as Secure Sockets Layer (“SSL”) are designed to provide communication security over the Internet. These processes and mechanisms have been used in the past to simplify certain SaaS operations somewhat; however, further simplification using these three mechanisms in combination to offer a SaaS-like application experience to a user, while maintaining data security, is desirable.

### SUMMARY OF THE INVENTION

Methods and systems for using a combination of encryption, authentication, and authorization to provide a software-as-a-service (“SaaS”) application to a customer of a SaaS provider, where the customer maintains certain administrative controls and the SaaS provider maintains certain administrative controls over elements of the system. Customer data may be maintained in a data source other than a domain of the SaaS application server, such as a data source secured by a trust-boundary of a data repository controlled by the customer. The methods and systems may include sending a SaaS software request from the client-computing device to a SaaS application server in order to receive SaaS software from the SaaS provider to install on the client-computing device, where the SaaS software is maintained by the SaaS provider. Executing, on the client-computing device, an executable application received from the SaaS provider in order to enable access to the customer's data in the data repository controlled by the customer, by the SaaS provider, in an authenticated manner.

The following detailed description together with the accompanying drawings will provide a better understanding of the nature and advantages of the present disclosure.

### BRIEF DESCRIPTION OF THE DRAWINGS

Various embodiments in accordance with the present disclosure will be described with reference to the drawings, in which:

FIG. 1 is an illustrative example of an environment in which various embodiments can be implemented;

FIG. 2 illustrates an environment in which various embodiments can be implemented;

FIG. 3 illustrates an environment in which various embodiments can be implemented;

FIG. 4 is an example illustration of a process according to at least one embodiment;

FIG. 5 is an example illustration of a process according to at least one embodiment;

FIG. 6 is an example illustration of a process according to at least one embodiment;

FIG. 7 is an illustrative example of a server-client environment in accordance with at least one embodiment;

FIG. 8 is an illustrative example of a server-client environment in accordance with at least one embodiment;

FIG. 9 is a block diagram illustrating an environment in which various embodiments can be implemented; and

FIG. 10 illustrates an environment in which various embodiments can be implemented.

### DETAILED DESCRIPTION OF THE INVENTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Example embodiments of the present disclosure relate generally to distributed computer applications and more particularly to distributed computer applications that use a common interface to provide access from computer applications remotely stored to user data secured behind a user trust boundary.

As described herein, a user's client device could be configured to execute software that is supplied as Software-as-a-Service (“SaaS”) software from a networked service that maintains, monitors and serves the SaaS software, where the user data used by that SaaS software is maintained locally on the user's client device or behind or within a user trust boundary maintained by the user or the user's agent or representative. In this approach, the user can use applications controlled by one entity with data that is controlled by the user and not by the one entity.

A Software-as-a-Service (SaaS) application might be configured to allow a user or customer to maintain their SaaS data on the customer's local machine for privacy and/or security reasons. For example, a local web server could be run on a hardware device that maintains an application configured to download from the SaaS application provider.

Example embodiments include systems and methods for managing a user-application using user-data located within a user-controlled data repository trust boundary according to Cross-Origin Resource Sharing permissions, Secure Socket Layer (“SSL”) protocols, and an open authorization (“OAuth2”) method of authentication.

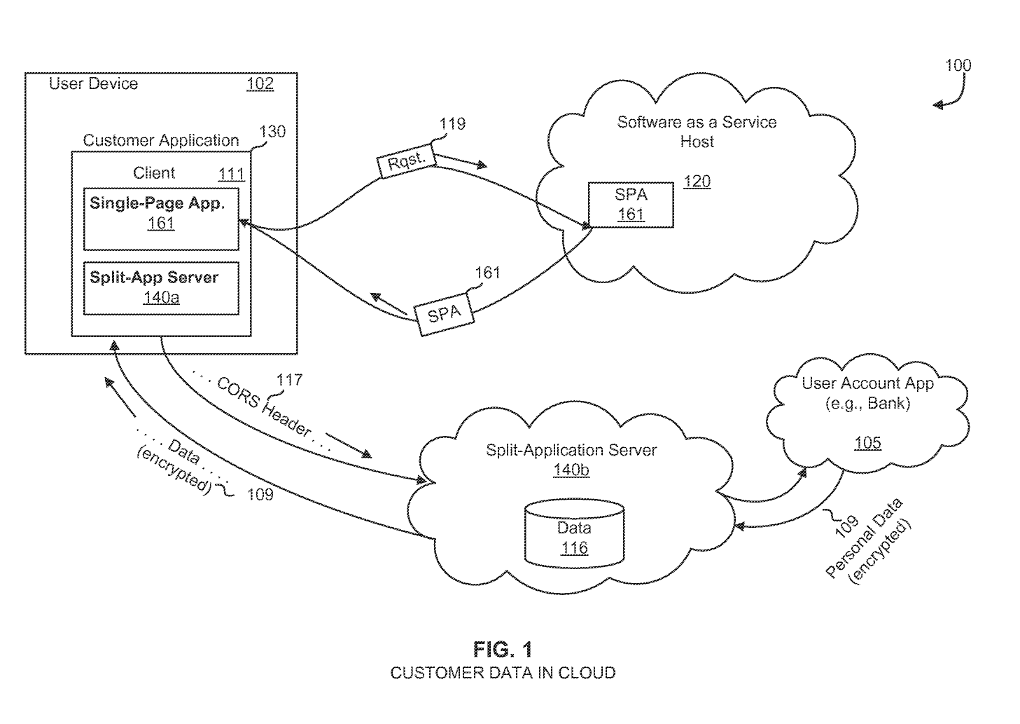

FIG. 1 illustrates an environment 100 disclosing an arrangement wherein the user data is stored remotely from a SaaS server, such as the SaaS Host 120, and from the user device, but still within a trust boundary controlled by the user or the user's organization.

As illustrated in FIG. 1, a single-page application (SPA) 161, which is served from a SaaS host 120 in response to the user request 119, accesses user data that is maintained by the user in a private customer cloud, where the customer cloud is a split-application server 140b. The user's data 109 may be maintained in a database 116 located on the split-application server running in the private customer cloud or in a third-part user account application 105. In this example embodiment, the client device 102 may be a local computer/network or a cloud service that runs a user application 130 via the client (browser) 111. The user controls the private customer cloud and trusts this as a data repository or data transfer bank. In the example shown, data is served in response to the user device request that includes at least one CORS header to grant access in order to receive user data that is maintained by the user. The CORS header may specify that the user data be maintained on the split-application server 140b or a split-application server 140a, running in client 111 and provides permissions for third-party access of the server.

In some example embodiments, a SaaS host 120, such as a SaaS provider or vendor of a software application provided as a service over the Internet, is configured to provide an application, such as the SPA 161, to a client, while the SaaS host only maintains administrative control over some of the systems that comprise the SPA. For example, a data source domain of the data source may be secured by a trust-boundary of a data repository. The data repository may be controlled by an operator of the client-computing device, where the operator of the client-computing device is a customer of the SaaS host 120. The customer may download software or receive software in another form from the SaaS host and install the software on the customer's client-computing device or enterprise system. The software provided by the SaaS host 120 enables the SaaS host to access the customer's data in an authenticated manner. The customer may maintain customer data on a customer trust domain and execute code provided by the SaaS host such that the customer maintains some administrative control to the system and the SaaS host maintains some administrative control.

The private cloud can be configured to receive instructions from a client 111 to access a user's account at a service 105, for example, such as a bank or brokerage account. The user may not want a service, such as service 120, to have control of user account information or user data from a separate source. Example embodiments enable the user's private cloud to provide user credentials to the bank source, as a third-party application, to receive the user data, and provide the user data back to the client 111. As the service 120 is not in control of a user's data and credentials, the user maintains control over their private information, but allows the network host of the SaaS to manage the application via the single-page application 161 according to the CORS header.

Example embodiments enable a user to receive their own encrypted data at a trusted source, which separates the problem of trusting and storing the user data at a cloud service, while still enabling the cloud service to manage the user's data from the application.

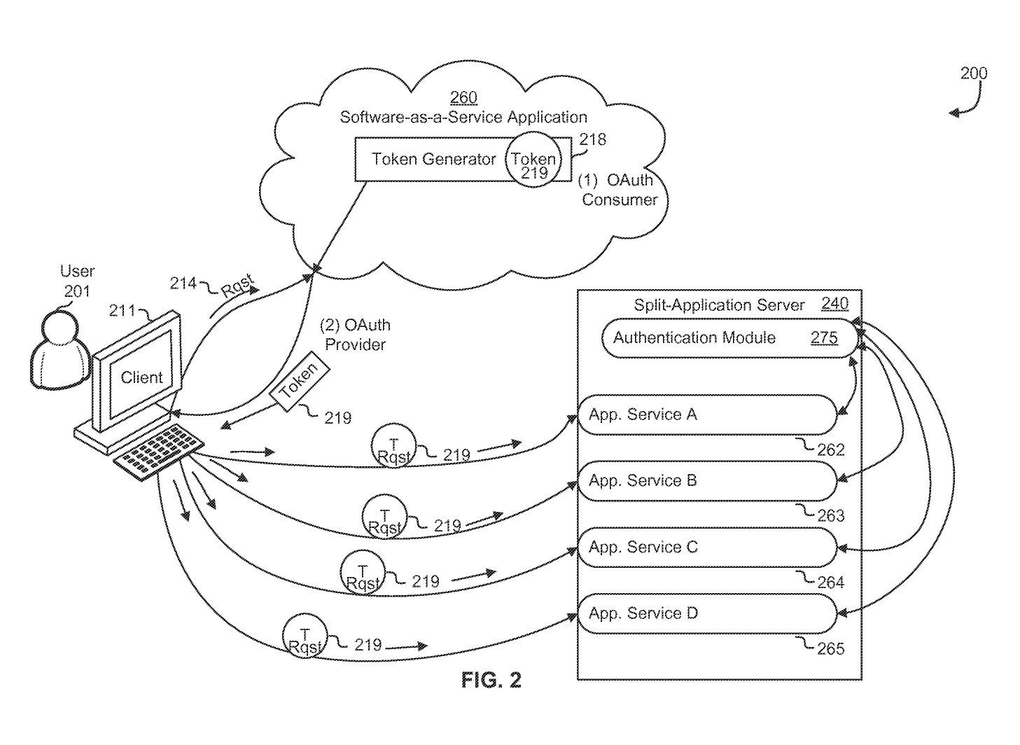

FIG. 2 illustrates an example environment 200 depicting a client and application using OAuth2 for authentication of credentials.

For systems including complex client-side applications, security issues must be addressed in order to solve many problems related to encryption, authorization, authentication, and resource sharing. For example, there are multiple components interconnected with an application in a cloud-based scenario, e.g., Internet-as-a-Service, Platform-as-a-Service, Algorithms-as-a-Service, Software-as-a-Service, etc. that require different levels and points of protection and/or security in order to ensure successful and secure communication of information between a client and a server. For example, TSL/SSL may be engaged to protect the transport channel between the client and the application, CORS may be implemented to protect the client (browser), and OAuth2 may be used to protect access to data.

For a brief review of the technologies, Secure Socket Layer (“SSL”) protocol uses SSL certificates, issued by a Certificate Authority, which includes a combination of public-key, private-key, and/or symmetric-key encryption for establishing a secure connection. In order to begin an SSL session, an exchange of messages (referred to as an SSL handshake) occurs between a client (web browser) and server (or application). In order for each to authenticate itself to the other, the server must obtain a digital certificate, containing a signature, from a certification authority (“CA”), which may be an entity that issues the digital certificates, in order to make a secure connection over a network, such as the Internet. The client is configured to use the CA certificate to verify the CA signature on the server's certificate as an element of the process before establishing the secure connection. Generally, client software, e.g., a browser, includes a set of trusted CA certificates; there are over 50 root certificates that are trusted by many clients.

When building complex client-side applications, at some point it usually becomes necessary to make XmlHttpRequests (“XHR”) requests to domains other than the one from which your page originated. Cross Origin Resource Sharing (“CORS”) enables web application developers to have a browser-supported mechanism to make XHR requests to another domain in a secure manner. If the script on your page is running from domain firstdomain.com and would like to request a resource via an XHR or XDomainRequest from domain seconddomain.com, this is a cross-origin request. For security reasons these types of requests have been prohibited by browsers in the past. CORS mechanisms work by adding HTTP headers to cross-domain HTTP requests and responses. These headers indicate the origin domain of the JavaScript program executing the XHR request and the server must indicate via headers in the response whether it will serve resources to a client from this origin domain. The CORS mechanism is automatically handled by the browser.

OAuth is an open standard for authorization, currently in its second generation referred to OAuth2, which provides client applications with a secure dedicated access to server resources on behalf of a resource owner. More specifically, OAuth2 specifies a process for resource owners to authorize third-party access to their server resources without sharing their credentials. OAuth2 essentially allows access tokens to be issued to third-party clients by an authorization server, with the approval of the resource owner, or end-user. The access token may contain user security credentials for a login session that may provide, for example, user privileges and application information. The client then uses the access token to access the protected resources hosted by the resource server. OAuth2 is commonly used as a way for web users to log into third-party web sites using their Google®, Facebook®, or other social media accounts, without worrying about their access credentials being compromised.

Returning to FIG. 2, the environment 200 illustrates an example of a user 201 forming a connection with application 260 via client 206. The example application 260 may be comprised of multiple application services, such as Service A 262, Service B 263, Service C 264, and Service D 265, which may be configuration services, and other portions or widgets that comprise portion of application 260. The services may be located on a split-application server 240, which may be configured to authenticate each of the application Services A-D within the split-application server, via an authentication module 275 or similar component using an open model for authentication.

In order for client 211 to communicate with the services 262-265, the client and application may use an open standard to authorization (“OAuth”) or OAuth2 authorization mechanisms to provide for authorized, secured transmission of data exchanged between the client browser and the cloud-based application. For example, the client 206 may send a request 214 to load a single-page application (“SPA”), for example, to application 260, followed by application 260 requesting an authorization access token from an external authentication service provider 270. In such an example, the application 260 is acting as an OAuth consumer (1), requesting an authorization from the provider. Assuming the request is valid, the provider will return a token 219 to the application.

Upon receipt of the token 219 at the application, the application becomes an OAuth provider (2), and, in response to the client's initial request, the single-page application running in the client receives the token 219. With receipt of the token, the client may now communicate directly with the application services 262-265 without having to have the token verified by the external authentication service provider 270 after each communication. For example, after the token 219 is received by the client, the client may issue an XHR request to load an SPA from Service A by providing the token, and then the Service A may verify the token. In alternative example embodiments, the client may receive the SPA, when the token 219 is capable of being self-verified by Service A, meaning there is no need for Service A to further verify the token.

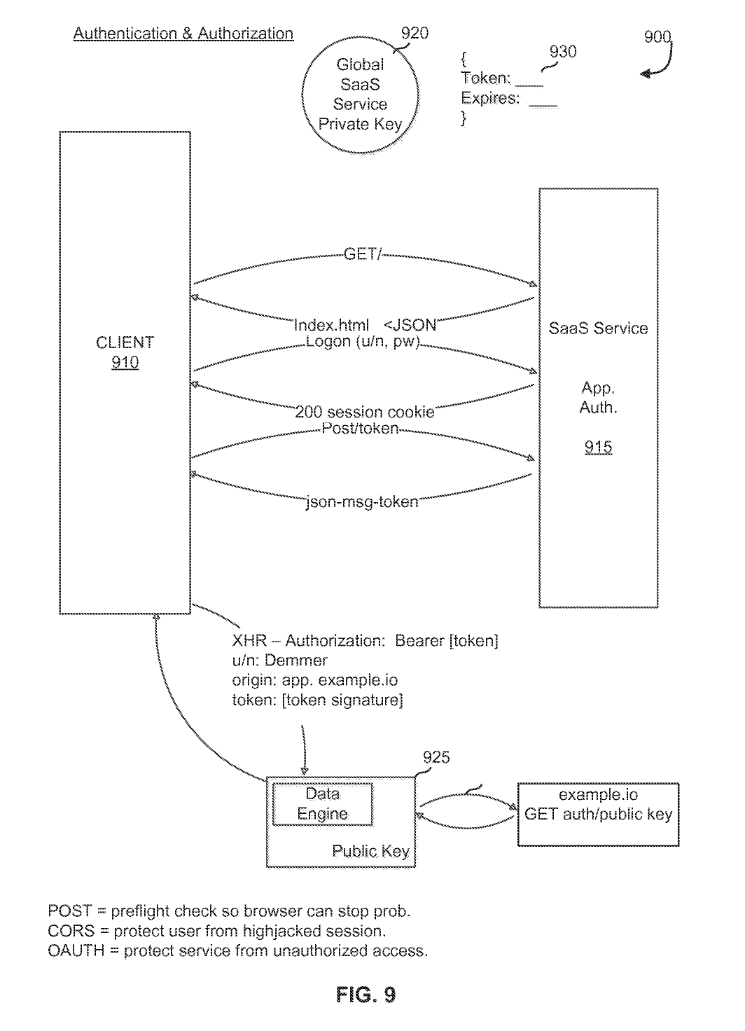

For example, a user 201 via the client 211 may sign in to a third-party application using a user name and password that will authenticate the user with the third-party application and create a new session with the server. Once authenticated, the server may direct the Software-as-a-Service application 260 generate a token 219 at a generator 218 and return the token back to the origin server. The client 211 may, then, issue an XHR request to Service A by including the token, which Service A may verify prior to allowing the XHR request to succeed. FIG. 9 provides additional details as to possible implementation using public-private key cryptography.

In alternative example embodiments, Services A-D may be further configured to verify the token 219 with an internal application authentication service 275 of the application 260, whereby upon receipt of a token 219 from client 206 to Service B, Service B may provide the token to the authentication service 275 requesting that the service verify the token.

In further example embodiments, the authentication service may act as a third-party authentication service, as is currently used in the industry, a user may request to load a SPA from the application, and, in response, the application may require the user to provide login credentials in order to proceed. These credentials can be a user's social media credentials, such as a Google® username and password, in which case the application may provide an iFrame or other window for the user to enter the user's Google® credentials, which is then transmitted to a Google® server for confirmation of correct credentials. If correct, the Google® server may return a token to the client, which may provide the token to the application. The third-leg of this current authentication process includes the application transmitting the receive token to the Google® server to confirm that the token is properly associated with the client attempting to access the application. Once properly authorized, the application may continue as normal with a proper authentication and authorization with the user over a secure channel.

In example embodiments, instead of this three-legged authorization (e.g., OAuth) process, a user may enter credentials for the application, in other words, specific user credentials directed at the application, and the application, via application authentication service 275 may confirm the credentials are correct and provide the token 219 directly to the user without the need for third-party verification.

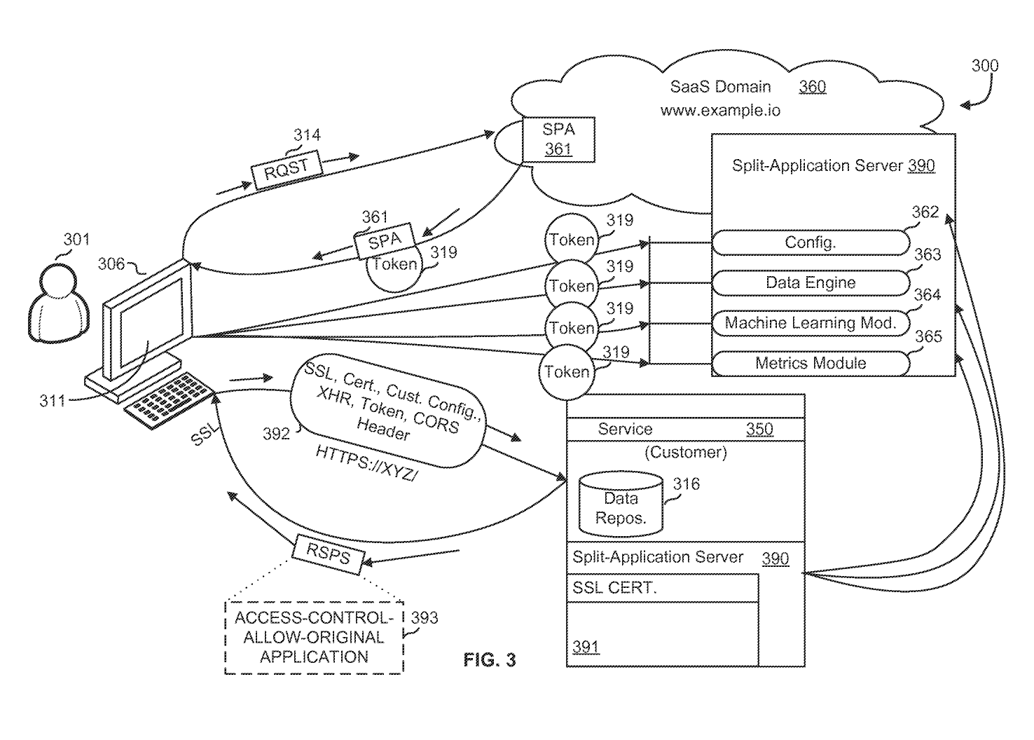

FIG. 3 illustrates an example environment 300 of a client, SaaS host, and split-application service using Cross-Original Resource Sharing (“CORS”) and OAuth to exchange traffic in a secure (“SSL”), authorized, and authenticated manner.

A user 301 using a client 311 running on a client device 302 transmits a request 314 for a single-page application (“SPA”) 361 via a previously established SSL channel to an application 360, which could be a Software-as-a-Service (“SaaS”) domain, for example. As noted above, the application 360 may be comprised of multiple components, applications, services, including a split-application server 390. The split-application server may include additional applications, services, and/or modules, such as a configuration service 362, a data engine service 364, a machine learning module 364, and a metrics module 365 that may, under previous systems, each require a request and response OAuth process to verify each request sent by the client.

However, according to example embodiments of the present disclosure, the application 360 may make a request for a token to the application's authentication service based on the information provided by the client (as discussed in detail in accordance with FIG. 9). Upon verification, the authorization service may provide a token to the application. The application, using the verified token, could provide the SPA 361 to client 311, including the token 319, which enables the client to transmit requests and receive responses from the service 350. The service 350, which may include a data repository 316 containing the customer's data, may have installed thereon or may be running via the client a split-application server 390. The split-application server 390 may maintain a TLS/SSL certificate 391 from a trusted authority indicating the DNS “XYZ” as specified in an XHR request 392, which may include the SSL certificate, configuration settings, the token, and a CORS header.

Example embodiments of the split-application server may be an installation made by the user, agent, or administration of the user's system to act as a trusted customer of the application, wherein the SSL certificate, or other certificate from another certificate authority includes the DNS that matches the DNS in the request from the client, thereby enabling the browser/client to authenticate itself with the split-application server. In response to the client from the split-application server, the split-application server response includes a header 393, which includes information that the service agrees to receive data and requests from the application. An SSL certificate coming from a trusted certificate provider includes attributes such as the domain of the SaaS service.

Example embodiments of the present disclosure may include providing a trust certificate that matches a certificate rooted in the application DNS, such that any time a user creates a new split-application server, the SaaS domain 360 is configured to create a new DNS entry for the node of the new data entry, thereby enabling the application to provide instructions to the client to use the DNS name created by the application. Alternative certificates may include self-signed certificates that require a client overriding a notification not to accept the self-signed certificate. Such a self-signed certificate from the application enables other services or sub-applications of the application to self-verify any tokens associated therewith.

For example, once the client has received the token 319, the client may communicate directly with any of the application services 362-365 by directly providing the token with a request message, without any further verification from the authorization service 390. Thus, in such an example, once the token is provided, the client may receive the SPA 361 or any other requested single-page application (or multi-page application) from any of the application services 362-365 without further OAuth steps.

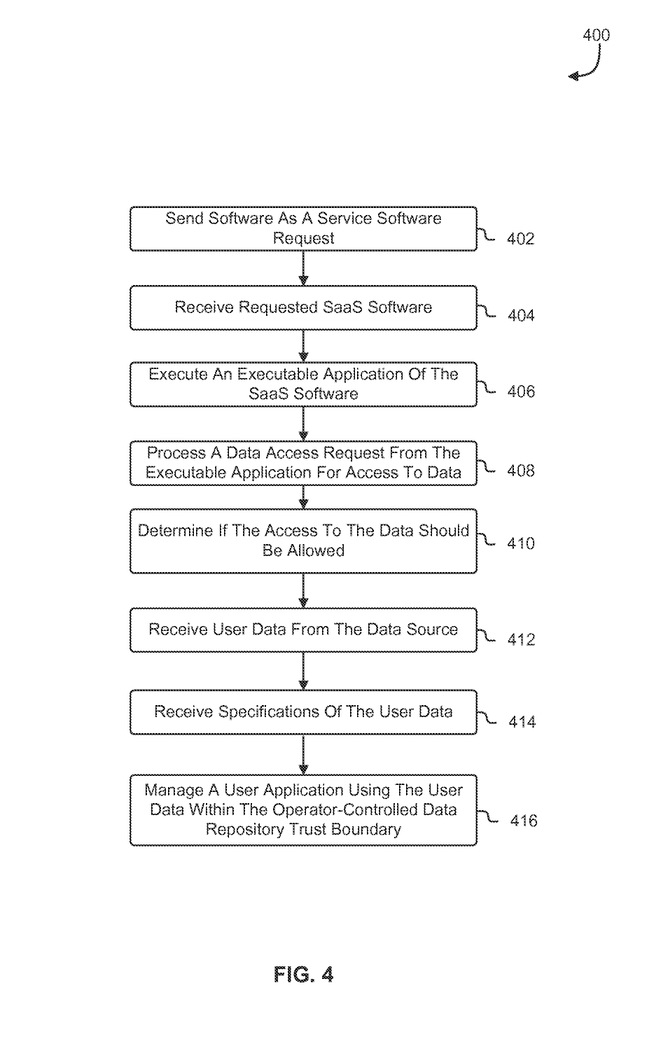

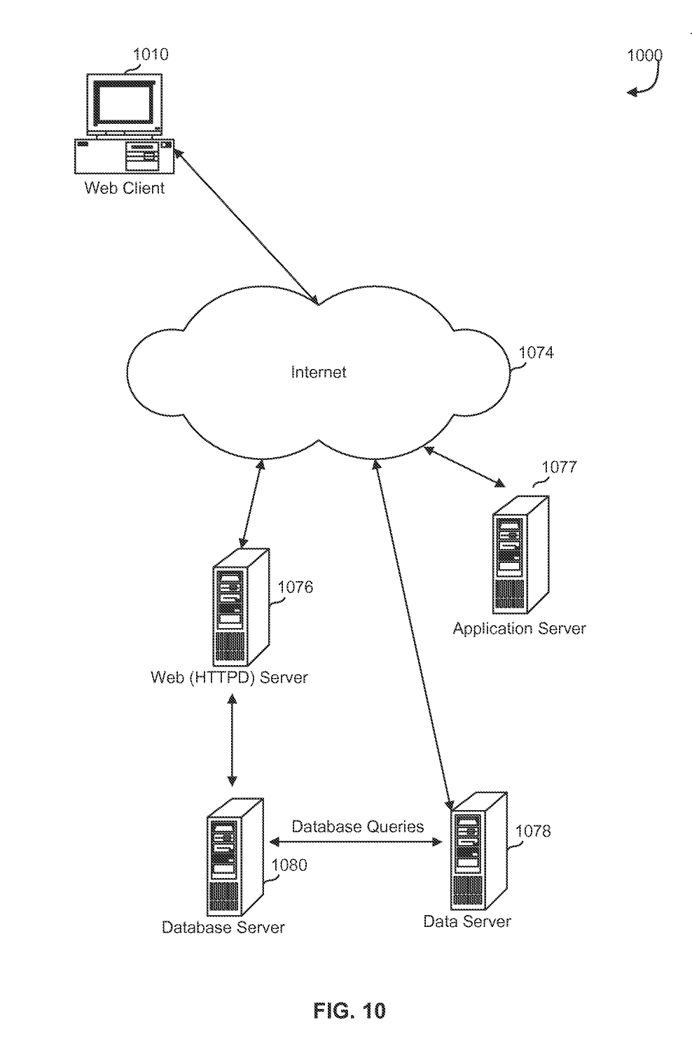

FIG. 4 is an illustrative example of a process 400 for executing software-as-a service software in accordance with at least one embodiment. The process 400 may be performed by any suitable system, such as by a web server, such as the web server 1076 illustrated and described in connection with FIG. 10 or any appropriate component thereof Returning to FIG. 4, the process 400 includes sending an XmlHttpRequests (“XHR”) request from the client-computing device, directed to a SaaS application server (402). It further includes receiving requested SaaS software in response to sending the XHR request (404), executing, on the client-computing device, an executable SPA from the SaaS application (406), and processing a data access request from the executable application for access to data from a data source other than a domain of the SaaS application server (408). For example, a data source domain of the data source may be secured by a trust-boundary of a data repository, where the data repository is controlled by an operator of the client-computing device. The process 400 further includes determining if the access to the data should be allowed and, if so, requesting data from the data source (410), receiving user data from the data source (412), receiving specifications, from a client, of the user data (414) and managing a user application using the user data within the operator-controlled data repository trust boundary, according to cross-origin requests permissions (416).

In some embodiments, a user device, such as a laptop computer running a Hypertext Transfer Protocol (“HTTP”) browser, requests a web application or single-page application from a split-application server controlled by a network service. The user device might make the request using HTTP, requesting a particular page or resource using a Uniform Resource Locator (“URL”), Universal Naming Convention (“UNC”), Uniform Resource Identifier (“URI”) or other specifier. In response to the request, if all is in order, the network service replies with a page containing some executable instructions. For example, the user device might make a request for a single-page application or other application written in the JavaScript® language, which the network service might provide, and then the user device may execute that application (subject to the constraints of JavaScript® language or other web application language).

For example, a user device may interact with a split-application server implemented in a network cloud service. In particular, a SaaS application may be running inside a client on the user device. Various browsers are known, implemented in software, hardware and/or firmware, and typically support HyperText Markup Language (“HTML”) rendering, execution of scripts and other active HTML content. In one operation, a SaaS application running inside a client makes an HTTP request for data, therein specifying a URL/URI that points to split-application server, directly or indirectly. In response, split-application server serves up an HTTP response, such as a single-page application (“SPA”). In this example, the SPA comprises digital data formatted as a SPA (or a plurality of SPAs, such as multi-page applications and/or links) that contains reference to at least one cross-origin header (such as a CORS header) and contains reference to at least one script and/or executable contained or referenced in SPA. A SaaS application can then render and present to the user the web user interface (“UI”) corresponding to SPA.

In some cases, portions of a script that is part of SPA and downloaded from split-application server will need to reference data outside the domain of split-application server. As explained in further detail herein, a cross-origin header might create an allowance for such an access that might be otherwise disallowed by security present in a SaaS application. In the example shown, data might be stored on a local hard drive or other local persistent memory, even though the script or executable that operates on that locally controlled data was downloaded from a different trust domain, e.g., a SaaS provider on the public Internet.

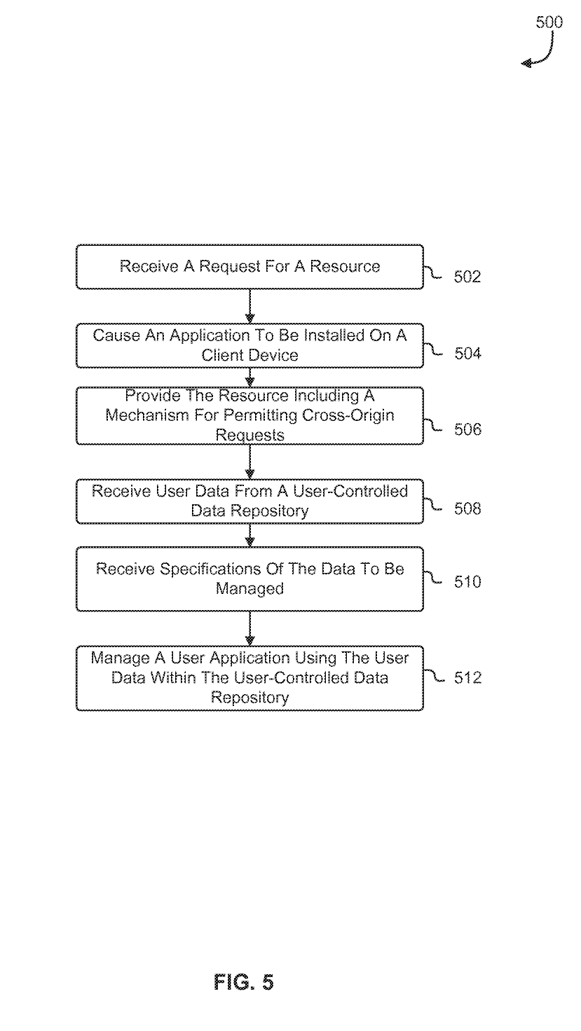

FIG. 5 is an illustrative example of a process 500 for executing software-as-a service software in accordance with at least one embodiment. The process 500 may be performed by any suitable system, such as by a web server, such as the web server 1076 illustrated and described in connection with FIG. 10 or any appropriate component thereof Returning to FIG. 5, the process 500 includes receiving, from a client, a request for a network resource (502). As a result of receiving the request, causing an application to be installed on a client device (504) and providing the network resource to the client including a mechanism for permitting cross-origin requests (506). The process 500 further includes receiving user data, at a client, from a user-controlled data repository (508), receiving specifications, from a client, of the user data to be managed (510), and managing a user application using user data within the user-controlled data repository, according to the cross-origin requests permissions (512).

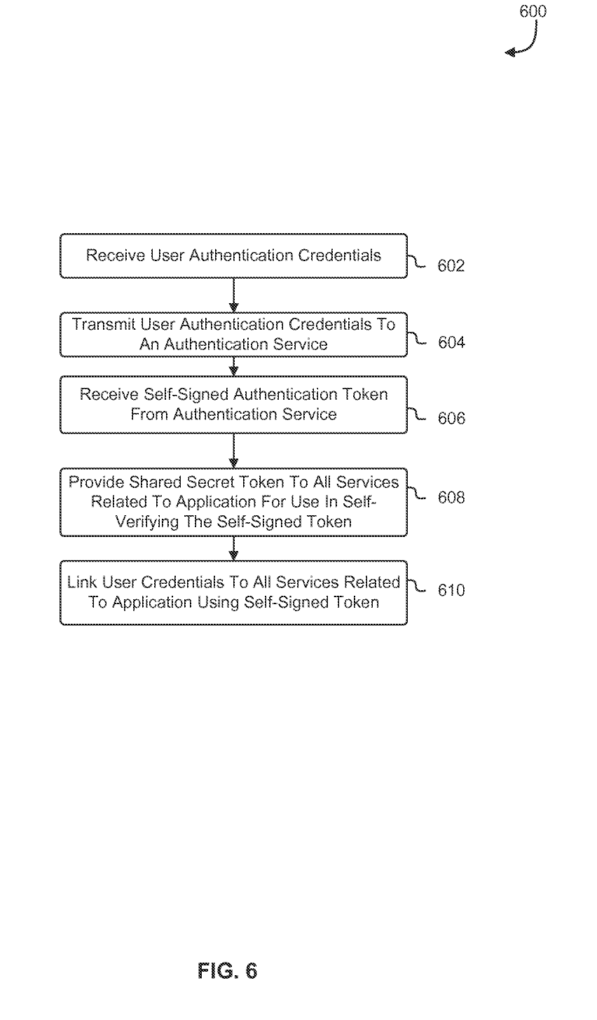

FIG. 6 is an illustrative example of a process 600 that may be used to provide open authorization for a user of a system as described herein.

Receiving a user's authentication credentials (602), where the credentials may be received at any module of the application, such as the application 600 illustrated and described in connection with FIG. 6. Returning to FIG. 6, transmitting the user's authentication credentials to an authentication service (604), such as the external authentication service provider 670 as illustrated and described in connection with FIG. 6. Returning to FIG. 6, receiving a signed authentication token from the authentication service (606) and providing a shared secret token to all services related to the application for use in self-verifying the self-signed token (608). The process 600 continues by linking a user's credentials to all services related to the application using the self-signed token (610). Example embodiments enable the self-signed token and/or a signed token to be verified by any of the services related to the application without said services needing to perform a second verification process.

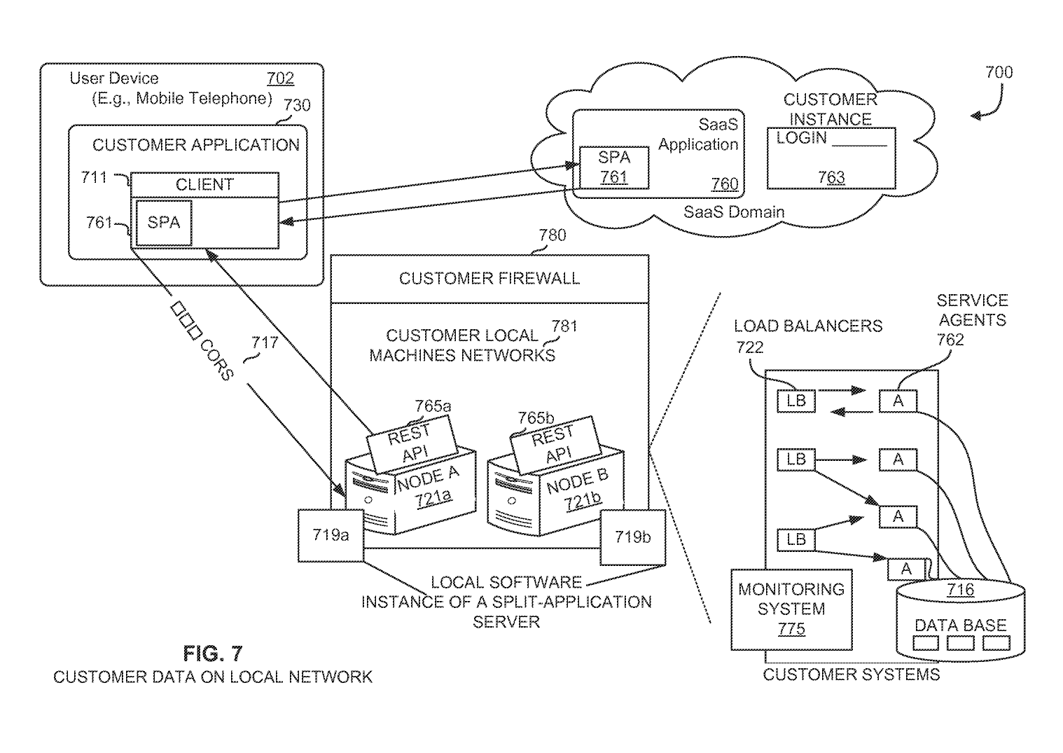

FIG. 7 illustrates an environment 700 depicting an arrangement wherein the user data is stored remotely from a split-application server on a user network, within a trust boundary controlled by the user or the user's organization.

A Software-as-a-Service application 760 may be operably interconnected with a user device running a single-page application (SPA) in a client, where the SPA may be configured to have access to and/or information relating to the user's nodes 721a and 721b that are behind a user's or company's firewall. The user's nodes, for example, may be part of a customer's local machine or network 781 and may be some or all nodes of the user's network. A user can have nodes as software that run on a user's machine and the user can manipulate that infrastructure using software as a service from the network service 760. The user's nodes can be configured, even though the nodes are behind a user firewall inside the user's service, to access the network service and be cloud-managed.

A user may access the network service by logging into their associated account 763 and request local software instances of a split-application sever 719a and 719b of the SaaS application to be installed directly onto the user's requested nodes. The network service may include a REST API 765 that cloud manages the customer's system or application via a monitoring system. The monitoring system 775 is configured with information regarding the customer's system, including, for example, the service agents 762, which can be service agents, load balancers 722 of the customer system, database 716, servers, switches, and other components of the customer system as desired by the user that want to be managed. As the service agents are installed or run on a user's system and provisioned to expose the infrastructure to the network service. The REST API is configured to collect data and perform analytics of the information being collected from this infrastructure.

As a user logs onto the Software-as-a-Service application 760, the network service serves single-page application (“SPA”) 761 that runs on a user's browser 706 that presents data and a user interface for the customer application 730. A user may have access to the nodes as software behind the user's firewall and manipulate that infrastructure using a SPA from the Software-as-a-Service application. A user's application data continues to be maintained behind a user's trust boundary, such as the user's firewall, however the network service may use the user's configurations and code to manage the user's nodes by making calls to the local data.

Example embodiments further include a user's client 706 being configured to interact with the user's REST API located behind the user's firewall, wherein the client is using software provide by the network service. The network service maintains, updates, and provides the software to the user for the user to run on the customer's system behind the customer's firewall, while the network service manages the mass of data from the user's system via the REST API. This software is separate from the software installed on the user's nodes and may be updated to resolve problems and provide updates without the user needing to manage that software.

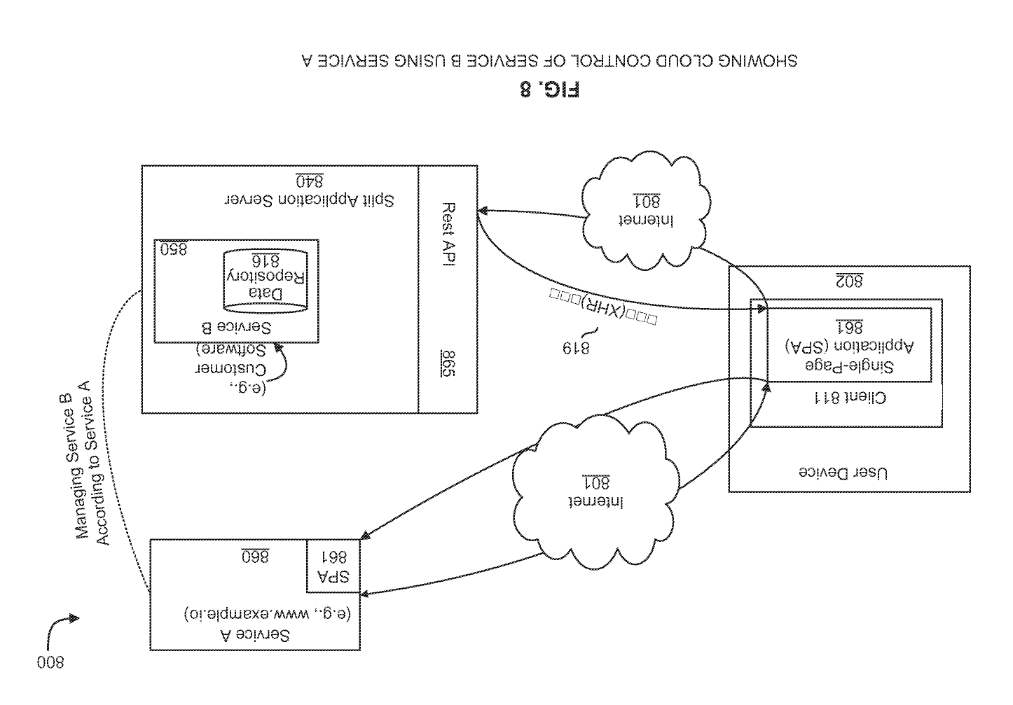

FIG. 8 illustrates an environment 800 depicting an arrangement wherein a first service manages a user application interconnected with a second service via a representational state transfer (REST) application programming interface (API). Example embodiments include an infrastructure that exposes a network service, such that data can be collected and analyzed for all data that is coming from the infrastructure by implementing the REST API to receive and filter data. A client 811 running on a user device 802, receives data from a first service, such as Service B 850, such that when a user accesses Service A 860, for example by logging on to their access of Service A, Service A can manage and analyze the data stored or provided by Service B without direct access to the data. The user device 802 requests a single-page application (“SPA”) from Service A and Service A returns JavaScript® code, or other code, as a single-page application to be used as the user interface 811 on the user's client 806.

Using a CORS header 817 received from Service A, and providing an XmlHttpRequests (“XHR”) request 819, from the browser to Service B, and Service B can exchange data with the browser and that data can be managed by Service A, where Service A is configured to manage the data without maintain or viewing the data. For example, the XHR request 819 may be a browser-specified mechanism by which it includes information in the request to a customer's data engine or software of Service B and provides information related to the location the single-page application originated. For example, the mechanism denotes an XHR request is being made with an origin from the single-page application URL, www.example.io.

FIG. 9 illustrates aspects of an example environment 900 for implementing aspects in accordance with various embodiments.

CORS is a client-specified mechanism by which a header included in the request contains information for the split-application server that provides for the origin domain. A split-application server, either running on a client 910 of the user's device or installed locally on a user's premises network, may be configured by the user to trust traffic transmitted from the Software-as-a-Service (“SaaS”) application. While using CORS protects a user, the client and the service are not necessarily secured.

In order to provide for secure transactions between a server and a client, Secure Socket Layer (“SSL”) protocol may be used. For example, the client may request a secure single-page application or webpage from a SaaS service 915, in turn, the SaaS service responds with a certificate containing a public key 925. The SaaS service may have a global SaaS service private key 920 or may use an individual private key for each customer. The SaaS service private key may be used to sign a certificate to be provided to the user as authorization with the service. Upon receipt of the public key, the client checks the certificate for authority and validates the public key, enabling the client to then use the SaaS service's public key to encrypt a symmetric encryption key and transmit the key, along with any encrypted data, to the SaaS service or component thereof. The SaaS service may decrypt the symmetric encryption key using the private key of the SaaS service, and use it to decrypt the data.

Last, the SaaS may be protected using an authentication method, such as open standard for authorization (“OAuth”). OAuth may be used to authenticate a session to protect the SaaS against unauthorized access. For example, a client may send a request for access to a service for the user, and if the SaaS application can grant access or limited access to the application. Once authenticated, the client is provided with a token 930 from the SaaS application (acting as an OAuth provider) and may then provide that token in a request to the Split-Application Server (“SAS”) from the client.

In example embodiments, when the authentication and authorization are combined/used together in such a manner, a customer may maintain their secured, private data (whether on a local machine or network, or stored in a cloud-service) via the SaaS application or service. The SaaS service may be configured to serve an application, such as a single-page application to a client running on a user's device. Once a user logs into a third-party application with a user name and password, which authenticates the user and creates a session in the server, a cookie is stored in the user's client such that the browser may present the cookie back to the server to identify that the client is authenticated.

FIG. 10 illustrates aspects of an example environment 1000 for implementing aspects in accordance with various embodiments. As will be appreciated, although a web-based environment is used for purposes of explanation, different environments may be used, as appropriate, to implement various embodiments. The environment includes an electronic client device, such as the web client 1010, which can include any appropriate device operable to send and/or receive requests, messages, or information over an appropriate network 1074 and, in some embodiments, convey information back to a user of the device. Examples of such client devices include personal computers, cell phones, laptop computers, tablet computers, embedded computer systems, electronic book readers, and the like. In this example, the network includes the Internet, as the environment includes a web server 1076 for receiving requests and serving content in response thereto and at least one application server 1077. It should be understood that there could be several application servers. Servers, as used herein, may be implemented in various ways, such as hardware devices or virtual computer systems. In some contexts, servers may refer to a programming module being executed on a computer system. The example further illustrate a database server 1080 in communication with a data server 1078, which may include or accept and respond to database queries.

It should be understood that elements of the block and flow diagrams described herein may be implemented in software, hardware, firmware, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (“RAM”), read only memory (“ROM”), compact disk read only memory (“CD-ROM”), and so forth. In operation, a general purpose or application specific processor loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments of the disclosure.

The foregoing examples illustrate certain example embodiments of the disclosure from which other embodiments, variations, and modifications will be apparent to those skilled in the art. The disclosure should therefore not be limited to the particular embodiments discussed above, but rather is defined by the claims.

While this disclosure has been particularly shown and described with references to example embodiments thereof, it will be understood by those skilled in the art that various changes in form and details may be made therein without departing from the scope of the disclosure encompassed by the appended claims.

Various embodiments of the present disclosure utilize at least one network that may be familiar to those skilled in the art for supporting communications using any of a variety of commercially-available protocols, such as Transmission Control Protocol/Internet Protocol (“TCP/IP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network and any combination thereof

In embodiments utilizing a web server, the web server can run any of a variety of server or mid-tier applications, including Hypertext Transfer Protocol (“HTTP”) servers, FTP servers, data servers, Java servers, and business application servers. The server(s) also may be capable of executing programs or scripts in response to requests from user devices, such as by executing one or more web applications that may be implemented as one or more scripts or programs written in any programming language, such as Java®, C, C# or C++, or any scripting language, such as Perl, Python or TCL, as well as combinations thereof

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof The code may be stored on a computer-readable storage medium, for example, in the form of a computer program comprising a plurality of instructions executable by one or more processors. The computer-readable storage medium may be non-transitory.

The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Further embodiments can be envisioned to one of ordinary skill in the art after reading this disclosure. In other embodiments, combinations or sub-combinations of the above-disclosure can be advantageously made. The example arrangements of components are shown for purposes of illustration and it should be understood that combinations, additions, re-arrangements, and the like are contemplated in alternative embodiments of the present disclosure. Thus, while the disclosure has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method for managing software as a service, comprising:
under the control of one or more computing devices configured with executable instructions, receiving, at a software-as-a-service provider, a request from a client;
providing a response to the client request, wherein the response includes a mechanism for permitting cross-origin requests and an application maintained by the software-as-a-service provider;
receiving user data, at the client, from a user-controlled data repository;
receiving specifications, from the client, of the user data to be managed; and
managing the application maintained by the software-as-a-service provider using the user data from the user-controlled data repository, according to cross-origin requests permissions.

2. The computer-implemented method of claim 1, wherein the at least one user node is operably interconnected with a user network security system.

3. The computer-implemented method of claim 2, wherein receiving specifications of the user data to be managed includes receiving access to the user data either directly or indirectly.

4. The computer-implemented method of claim 2, wherein the user-controlled data repository is located within a user's security domain.

5. A system, comprising:
at least one computing device configured to implement one or more services, wherein the one or more services are configured to:
receive a request at a first service, wherein the first service includes multiple applications;
as a result of receiving the request, transmit a request for an access token for use by a client of the first service;
provide the access token to the client, wherein the access token enables the client to access resources of the first service without verification of credentials of the client for requests to one or more of the multiple applications of the first service;
provide a response to the request to the client on a client device including a permissions for cross-origin requests;
receive user data, at a client, from a second service, the second service being operably interconnected to the client device;
receive specifications, at the first service, of the user data to be managed; and
manage, by the first service, at least a portion of the second service according to cross-origin requests permissions.

6. The system of claim 5, wherein the one or more services are further configured to establish a trust boundary between a client and a server either by providing single-sign on credentials or delegating third-party open authorization.

7. The system of claim 6, wherein the trust boundary is located on a client-side apparatus.

8. The system of claim 5, wherein the first service is a cloud-based service.

9. The system of claim 5, wherein the first service includes multiple services configured to maintain a shared secret token for self-verification of a signed token.

10. The system of claim 5, further including at least one user node operably interconnected with a user network security system.

11. The system of claim 5, wherein the response includes a single page application for running a user interface for the user application.

12. The system of claim 5, wherein the second service includes a security domain of the user and includes user hosted storage.

13. A non-transitory computer-readable storage medium having stored thereon executable instructions that, when executed by one or more processors of a computer system, cause the computer system to at least:
transmit an Software-as-a-Service (SaaS) software request from a client computing device, directed to an SaaS application server;
receive a signed access token from the SaaS application server;
receive requested SaaS software in response to sending the SaaS software request;
execute, on the client computing device, an executable application of the requested SaaS software;
transmit a second SaaS software request from the client computing device to a sub-application of the SaaS application server using the signed access token;
process a data access request from the executable application for access to data from a data source other than a domain of the SaaS application server, the request being part of the requested SaaS software, wherein a data source domain of the data source is secured by a trust boundary of a data repository controlled by an operator of the client computing device;
determine if the access to the data should be allowed and, if so, requesting data from the data source;
receive user data from the data source;
receive specifications, from a client, of the user data; and
manage a user application using the user data within the operator-controlled data repository trust boundary, according to cross-origin requests permissions.

14. The non-transitory computer-readable storage medium of claim 13, wherein the instructions further comprise instructions that, when executed by the one or more processors, cause the computer system to provide a signed certification to a client.

15. The non-transitory computer-readable storage medium of claim 13, wherein the instructions further comprise instructions that, when executed by the one or more processors, cause the computer system to enable the SaaS application server to include multiple sub-applications or multiple sub-services.

16. The non-transitory computer-readable storage medium of claim 15, wherein the instructions that cause the computer system to include multiple sub-applications or multiple sub-services further include instructions that cause the computer system to enable the multiple sub-applications or the multiple sub-services to self-verify the signed certificate from the application.

17. The non-transitory computer-readable storage medium of claim 16, wherein the instructions further comprise instructions that, when executed by the one or more processors, cause the computer system to provide the received signed certificates to an internal authorization service to verify the signed certificate.
